(19) United States
(12) Patent Application Publication
(10) Pub. No.: US 2006/0274959 A1
(43) Pub. Date: Dec. 7, 2006

(54) Image processing to reduce blocking artifacts

(76) Inventor: Patrick Piastowski, Herne (DE)

Correspondence Address: O'Shea, Getz & Kosakowski, P.C.;Suite 912, 1500 Main Street, Springfield, MA, 01115, US

(21) Appl. No.: 11/447,222

(22) Filed: Jun. 5, 2006

(30) Foreign Application Priority Data
Jun. 3, 2005 (DE) 10 2005 025 629.5

(51) Int. Cl. G06K 9/40

(52) U.S. Cl. 382/268

(57) ABSTRACT

Processing to reduce blocking artifacts in an image comprising a first image block and a second image block separated by a block boundary, includes, generating a main gradient value which is a function of a first pixel difference between a first pixel located in the first image block a second pixel located in the second image block, where the first and second pixel are located adjacent to each other on a first axis running vertically relative to the block boundary. In addition, at least one secondary gradient value is generated which is a function of a second pixel difference between at least two pixels located adjacent to each other in the first image block on the first axis, and a function of a third pixel difference between at least two pixels located adjacent to each other in the second image block on the first axis. The first and second image blocks are filtered, at least in the region of a block boundary between the first and second image blocks as a function of a ratio between the main gradient value and the at least one secondary gradient value.

### PRIORITY INFORMATION

This patent application claims priority from German patent application 10 2005 025 629.5 filed Jun. 3, 2005,which is hereby incorporated by reference.

### BACKGROUND OF THE INVENTION

The invention relates to the field of image processing, and in particular to reducing blocking artifacts in images that have been reconstructed from transferred image information.

The transfer of image information may include a spatial to temporal transfer of image information, that is, a storing and retrieval of image information. A known approach to transferring image data is to subdivide the individual images to be transferred into blocks, each one having multiple pixels, and to quantize and encode block-by-block the image information values associated with the individual pixels. A procedure of this type is found, for example, in the MPEG method. The quantization may vary for individual blocks.

When these image data are received, a block-by-block decoding of the image data is performed to reconstruct the transferred image. The quantization of the individual image blocks is necessarily associated with a loss of information that can result in visible edges at the block boundaries during the reconstruction. The term used in this context is “blocking” artifacts. These artifacts can be especially prominent when a very rough quantization is provided corresponding to large quantization parameters.

In the MPEG method, in addition to the encoded image data, the respective quantization parameters for the individual macroblocks are transferred as supplemental information, for which macroblocks multiple image blocks are combined. This supplemental information can be used during decoding of the image data to reduce blocking artifacts.

One method of decoding image data that uses supplementally transferred quantization information is, for example, described in Kim et al: “A Deblocking Filter with Two Separate Modes in Block-Based Video Coding”, IEEE Transactions on Circuits and Systems for Video Technology, Vol. 9, No. 1. February 1999. This method forms part of the MPEG-4 standard (see ISO/IEC 14496-2,entitled Information Technology-Coding of Audio-Visual Objects, Amendment 1:Visual Extensions, 15.07.2000,F.3.1).

In this known method, the individual images are reconstructed based on the transferred quantized image information, and the reconstructed images are subjected to post-processing in the form of filtering. The known method distinguishes between two different filter modes: a first filter mode for detailed, that is, nonhomogeneous image regions (default mode), and a second filter mode for homogeneous image regions (DC offset mode). The type of filter is selected based on a flatness measurement that comprises an evaluation of local pixel differences into and up to the center of two given adjacent blocks. Local pixel difference indicates the difference between the image information values of two adjacent pixels. In the case of horizontally running block boundaries, the pixels from ten image lines are considered. Specifically: the pixels from five image lines above the block boundary and the pixels from five image lines below the block boundary. In the known method, the received quantization parameters for each block boundary are used to decide whether the selected filtering technique should be implemented.

In the first filter mode (default mode), the filtering modifies only two adjacent pixels on a block boundary. The basis of the filter is three partially overlapping four-dot DCTs and one IDCT. In the second filter mode (DC offset mode), a 9-tap filter is employed that modifies four pixels each from the two adjacent blocks that are contiguous at the block boundary, and which thus extend far into the two adjacent blocks.

The known technique is applied first to all the horizontal block boundaries, then to all the vertical block boundaries. It offers an effective blocking reduction with a tendency toward blurring in homogeneous regions.

Another method of decoding transferred image data that utilizes quantization information is described in Ramkishor et al: “A Simple and Efficient Deblocking Algorithm for Low Bit-Rate Video Coding”, IEEE International Symposium on Consumer Electronics, Hong Kong, China, December 2000. In this method, a simple classification function is used containing two subtractions and a few simple operations to decide whether a strong blocking effect or a weak blocking effect is present at an examined block boundary. Depending on which of these two blocking effects is detected, filters of varying effective widths are used to post-process the received image. Given a weak blocking effect, a filter with an effective width of four pixels is used, that is, two pixels each adjacent to the block boundary are modified by the filter. Given a strong blocking effect, a filter is employed having an effective width of six pixels. In this method, the transferred quantization information is also utilized to fundamentally decide whether filtering of the received image for postprocessing purposes is implemented.

A problem with the two above-described methods is that additional information aside from the image information must be transferred or be present to reduce the blocking artifacts.

One method that does not require this additional information is described, for example, in “Reduction of Blocking Artifact Images Using Wavelet Transform”, IEEE Transactions on Circuits and Systems for Videotechnology, Vol. 8, No. 8,June 1998.This method is based on a two-stage wavelet transform and thus involves a not-inconsiderable implementation complexity. In addition, with this method the processing of image data is performed in the horizontal axis and vertical axis separately, and for certain operations during the processing of horizontal block boundaries it should ideally be possible to access all the image lines of the image. This entails a significant utilization of memory, or requires an image memory.

Wu et al: “A Generalized Block-Edge Impairment Metric for Video Coding”, IEEE Signal Processing Letters, Vol. 4, No. 1 1, November 1997, pages 317 to 320, describes a method in which the presence of blocking artifacts is determined exclusively on the bases of pixel differences.

There is a need for an image processing technique for reducing blocking artifacts that requires no supplemental information beyond the transferred image data or image information, such as, for example, quantization information.

### SUMMARY OF THE INVENTION

Processing to reduce blocking artifacts in an image comprising a first image block and a second image block separated by a block boundary, includes, generating a main gradient value which is a function of a first pixel difference between a first pixel located in the first image block a second pixel located in the second image block, where the first and second pixel are located adjacent to each other on a first axis running vertically relative to the block boundary. In addition, at least one secondary gradient value is generated which is a function of a second pixel difference between at least two pixels located adjacent to each other in the first image block on the first axis, and a function of a third pixel difference between at least two pixels located adjacent to each other in the second image block on the first axis. The first and second image blocks are filtered, at least in the region of a block boundary between the first and second image blocks as a function of a ratio between the main gradient value and the at least one secondary gradient value.

The ratio between the main gradient value and the secondary gradient value provides information about the presence of blocking artifacts in the region of the block boundary between the first and second image blocks. When the ratio of the main gradient value to the secondary gradient value indicates the presence of a blocking artifact, filtering of the first and second image blocks is effected, at least in the region of the block boundary, with the goal of reducing blocking artifacts.

In one embodiment, the ratio of the main gradient value to the secondary gradient value is generated so as to obtain a blocking value, and the filtering is implemented as a function of whether this blocking value lies above or below a predetermined threshold value.

Whenever the ratio of the main gradient value to the secondary gradient value indicates the presence of a blocking artifact in the region of a block boundary, filtering is selectively performed on the first and second image blocks in the region of the block boundary, preferably, as a function of the secondary gradient value by a first or a second filtering technique. The secondary gradient value contains information on the homogeneity of the two image blocks in the region of the block boundary. If this secondary gradient value indicates that the homogeneity of the image blocks is high, then filtering is performed by the first filtering technique, while if the secondary gradient value indicates that the homogeneity of the image blocks is low, then filtering is effected by a second filtering technique. The two filtering techniques include a first filtering technique to reduce artifacts for homogenous image blocks, while a second filtering technique is employed for nonhomogeneous, that is, “active” image blocks. The filter for the first filtering technique preferably has a higher effective width than the filter for the second filtering method. The “effective width” of the filter identifies the number of pixels adjacent to the block boundary that are being modified by the given filter.

In one embodiment, the presence of a unilateral homogeneity in the two first and second image blocks adjacent to the block boundary is determined, and the main gradient value is weighted as a function of the presence of this local homogeneity. The presence of unilateral homogeneity may be determined by examining the pixel differences between pixel pairs located adjacent to each other on an axis parallel to the block boundary.

In the presence of this unilateral homogeneity, the main gradient value is preferably increased. The reason for this is that blocking artifacts at block boundaries are particularly conspicuous whenever a local homogeneity is present in one of the two blocks in a region adjacent to the block boundary. In order in this case to preferentially invoke filtering of the two image blocks, the main gradient value is increased in response to unilateral homogeneity.

These and other objects, features and advantages of the present invention will become more apparent in light of the following detailed description of preferred embodiments thereof, as illustrated in the accompanying drawings.

### BRIEF DESCRIPTION OF THE DRAWINGS

FIGs. 1A & 1B pictorially illustrate a segment of an image subdivided into image blocks illustrating the calculation of a main gradient value and a secondary gradient value;

FIG. 2 illustrates an example of a plot of the image information values of homogeneous image regions adjacent to a block boundary, and a plot for these image information values after filtering; and

FIG. 3 illustrates an embodiment of a filter to implement the filtering described based on FIG. 2.

### DETAILED DESCRIPTION OF THE INVENTION

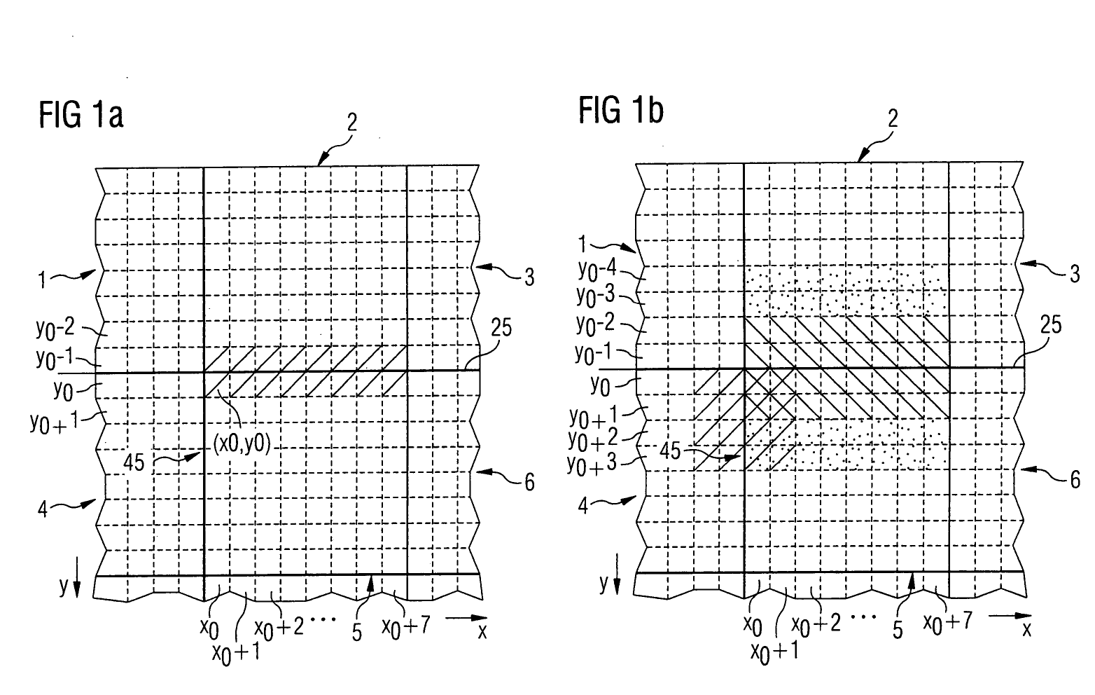

FIGS. 1A and 1B pictorially illustrate a section of an image subdivided into multiple image blocks. Each of the individual image blocks has a number of adjacent pixels, for example a matrix of 8×8 pixels. The individual pixels are associated with specific image information values.

The image is, for example, reconstructed from an image data stream transferring quantized image information. Due to the quantization of the image information values before the data transfer, an inevitable loss of information occurs that can manifest itself in the reconstructed image as blocking artifacts at the block boundaries between adjacent image blocks. A blocking artifact of this type displays, for example, a visible line in the image along the block boundary between the two blocks.

The following discussion examines the vertically adjacent first and second image blocks 2, 5, between which runs a block boundary 25. A vertical axis of the image section is designated as the y-axis, while a horizontal axis is designated as the x-axis. The pixels of the image located adjacent to each other on the x-axis are designated as pixels of an image line, while the pixels adjacent to each other on the y-axis are designated as pixels of an image column.

The presence of blocking artifacts in the region of the block boundary 25 is first detected, and the two image blocks 2, 5 are filtered at least in the region of the block boundary 25 whenever the presence of a blocking artifact has been detected. In order to detect blocking artifacts, a main gradient is first determined which is a function of the pixel difference between at least two pixels adjacent to the block boundary 25, and this main gradient is compared with a secondary gradient that is a function of the pixel difference between at least two pixels located adjacent to the block boundary 25 but are located respectively in the first image block 2 and the second image block 5.

Two adjacent pixels that are considered for the determination of the pixel difference each lie adjacent to each other in a first axis running vertically relative to the block boundary 25. This first axis corresponds to the y-axis of the image sections indicated in FIGs. 1A and 1B.

Generation of the main gradient value is effected, for example, by examining all the pixel pairs, of which one pixel lies in the first image block and one pixel lies in the second image block, the pixels of the pairs being located immediately adjacent to each other separated by the block boundary 25 . Pixel differences are determined for these pixel pairs by subtracting the image information values associated with these pixels, and summing the absolute values of these pixel differences to generate the main gradient value. The main gradient value HG₂₅ of the block boundary 25, may be expressed as:

$${HG}_{25} = {\sum }_{n = 0}^{7} abs ( s ( {x}_{0} + n , {y}_{0} - 1 ) - s ( {x}_{0} + n , {y}_{0} ) ) , \qquad ( 1 )$$

where abs(.) denotes the operator for generating the absolute value.

Pixel (xₒ, yₒ), which in the example is located in the left upper corner of the second image block 5, serves in terms of the explanation of the method as a reference point for the pixels considered when determining the main gradient value HG₂₅. These pixels considered to determine the main gradient value HG₂₅ are shown in hatched form in FIG. 1A. These are the pixels located in image line yₒ of the second image block 5, and the pixels located in image line yₒ-1 of the first image block 2. The column positions of the pixels located in the two blocks are denoted by x_{O} through x_{O}+7.

The main gradient value HG₂₅ provides information on the variations between the image information values beyond the block boundary 25. The main gradient value HG₂₅ thus becomes larger the more strongly the image information values of the pixels adjacent to the block boundary 25 of the first and second image blocks 2, 5 deviate from each other.

A secondary gradient value NG₂₅ contains information about the homogeneity within the two image blocks 2, 5. This secondary gradient value NG₂₅ is determined, for example, as follows:

$$\begin{matrix}{NG}_{ 25} = 0.5 \cdot [ {\sum }_{n = 0}^{7} abs ( s ( {x}_{0} + n , {y}_{0} - 2 ) - s ( {x}_{0} + n , {y}_{0} - 1 ) ) + \\ {\sum }_{n = 0}^{7} abs ( s ( {x}_{0} + n , {y}_{0} ) - s ( {x}_{0} + n , {y}_{0} + 1 ) ) ] .\end{matrix} \qquad ( 2 )$$

The pixels referenced for the determination of the secondary gradient value are highlighted in hatched form in FIG. 1B.

To determine the secondary gradient value NG₂₅ in this example, the pixel differences between all the pixel pairs are determined in the first and second image blocks 2, 5 that are adjacent to each other on the y-axis, and of which one pixel lies immediately adjacent to the block boundary 25 in the first or second image block 2, 5. The absolute values of the pixel differences thus determined are summed. In order to be able to relate the secondary gradient value NG₂₅, for the determination of which double the number of pixel pairs must be considered than are needed to generate the main gradient value HG₂₅, the summed absolute values of the pixel differences are multiplied by the factor 0.5.

In a natural non-quantized image, a main gradient value generated by the approach discussed above corresponds on average to a secondary gradient value generated by the approach explained above. The quantization losses described in the introduction result in discontinuities in the region of the block boundaries, while for the interior of these blocks an information loss can be observed in the form of a homogenization. As a result, the main gradients become larger and the secondary gradients become smaller, with the result that the ratio of the main gradient to the secondary gradient is suitable for detecting blocking artifacts.

As the measure for the presence of such blocking artifacts, in one embodiment a blocking value BL₂₅ is generated from the main gradient value HG₂₅ and that secondary gradient value NG₂₅, which can be expressed as:
BL₂₅=HG₂₅/NG₂₅ (3).
In a natural non-quantized image, this blocking value is approximately one. Given a blocking value of BL₂₅ which lies above a predetermined threshold value, the presence of a blocking artifact is assumed and filtering of the two image blocks 2, 5 is implemented at least in the region of the block boundary 25.

In the method explained based on FIG. 1A, all those pixels of the first and second image blocks 2, 5 are utilized in the determination of the main gradient value which are located immediately adjacent to the block boundary. However, it is contemplated only a few of the pixel pairs (x_{O}+n,y_{O}),(x_{O}+n,y_{O}−1), where n=O . . . 7 may be considered for the determination of the main gradient value. For example, only every other pixel pair may be utilized for the determination of the main gradient value HG₂₅, that is, the pixel pairs with pixels (x_{O}+n,y_{O}), (x_{O}+n,y_{O}-1), where n=1,3,5,7,or more generally only every i^{th} pixel pair, where i is an integer along the block boundary 25.

While pixel pairs in the first and second image blocks are considered in the example of FIG. 1B to generate the secondary gradient value in the first and second image blocks 2, 5, of which one pixel immediately adjoins the block boundary 25, it is of course also possible to utilize additional pixels within the image blocks 2, 5 to generate the secondary gradient value. For example, when generating the secondary gradient value NG₂₅, pixels may also be considered that lie further removed from the block boundary 25 in the direction of the center of the block. As applied to the example of FIG. 1B, this means that when determining the secondary gradient value NG₂₅ it is also possible to consider pixels which in the first and second image blocks 2, 5 lie in image lines y_{O}−3 and y_{O}−4 or y_{O}+3 and y_{O}+4. It is also possible to utilize pixels that are even further removed from the block boundary for the determination of the secondary gradient value.

The filtering implemented after detection of a blocking artifact is preferably a function of how homogeneous the image blocks 2, 5 are in the region of the block boundary 25. One measure of the homogeneity of the two image blocks 2, 5 in the region of the block boundary 25 is provided by the secondary gradient value which becomes smaller as the two image blocks 2, 5 in the region of the block boundary 25 become more homogeneous. If the secondary gradient value lies below a predetermined threshold value, a first filtering method is implemented to filter the image blocks 2, 5 in the region of the block boundary 25, otherwise a second filtering technique is implemented to filter the image blocks 2, 5.

To the extent different filtering techniques are used as a function of the homogeneity of the regions adjacent to the block boundary 25, it is also possible to decide whether or not to implement filtering as a function of the homogeneity of the image regions. The threshold value of the blocking value BL₂₅ that is utilized for the filter decision is then dependent on the homogeneity of the image regions adjacent to the block boundary or dependent on the secondary gradient value. If the secondary gradient value lies within a range that indicates a homogeneity of these image regions (e.g., below a predetermined threshold value) then a first threshold value is utilized for the filter decision. If the secondary gradient value lies within a value range that indicates a nonhomogeneity (i.e., activity) of these image regions, in other words above the predetermined threshold value, then a second threshold value is utilized for the filter decision. The first threshold value of the blocking factor BL₂₅ is, for example, 5/3, so that filtering is implemented by the first filtering technique when a homogeneity is detected based on the secondary gradient value and when the blocking factor BL₂₅ is greater than or equal to 5/3. The second threshold value of the blocking factor BL₂₅ is, for example, 7/3,so that filtering is implemented by the second filtering technique when a homogeneity is detected based on the secondary gradient value and when the blocking factor BL₂₅ is greater than or equal to 7/3.

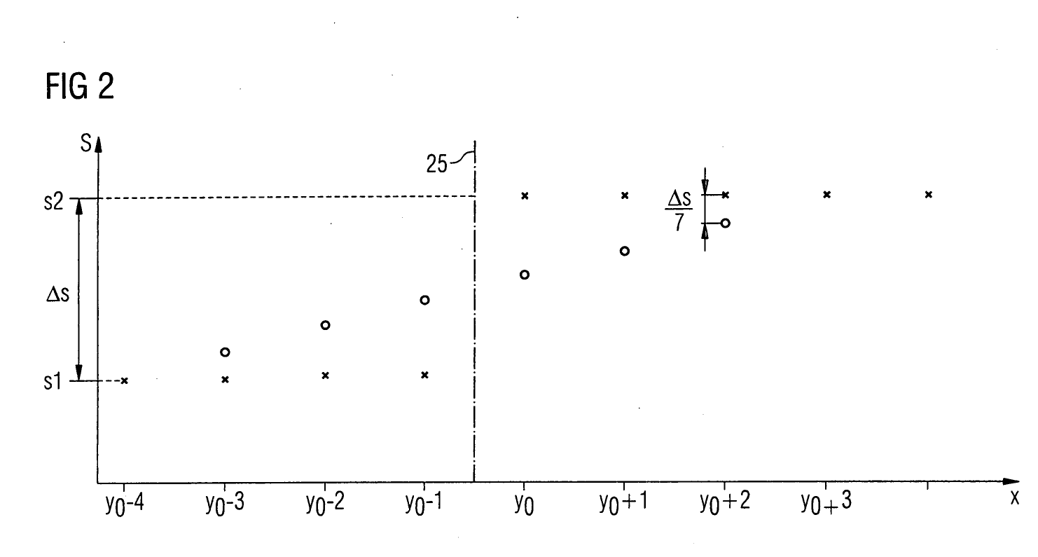

An example of a first filtering technique implemented for an assumed homogeneity within the two image blocks 2, 5 is explained below based on FIG. 2.

FIG. 2 illustrates by way of example the image information values of the pixels that are located in an image column above and below the block boundary 25. Assume that the image region of the first image block abutting the block boundary is a homogeneous image region, and that the image region of the second image block abutting the block boundary is a homogeneous image region. The image information values of the pixels of the first image block have a common image information value of sl, while the image information values of the pixels of the second image block 5 have a common second image information value of s2. The term Δs denotes the difference between these image information values. This difference between the image information values of the respective homogeneous image regions of the first and second image blocks 2, 5 results in a visible jump in intensity along the block boundary. In order to reduce this visible jump, the two image blocks 2, 5 in the region of the block boundary 25 are filtered such that the transition from pixels of the image information value sl in the first image block 2 are smoothed relative to pixels of the second image information value s2 in the second image block 5. The filtering is effected, for example, by modifying the image information values of three pixels each above and below, or to the left and right of, the block boundary 25 to produce a linear rise or linear fall in the curve of the image information values in the region of the block boundary 25. The effective width of this type of filter generating a linear rise is six pixels.

The filter determines, for example, the difference between the image information value of the pixel located immediately adjacent to the block boundary 25 in the first block and the image information value of the pixel located immediately adjacent to the block boundary 25 in the second block 5, divides this difference by w+1, where w represents the number of pixels to be modified. A multiple of the fraction thus obtained is added to the original image information values, or subtracted therefrom, to obtain the linear rise described in FIG. 2.

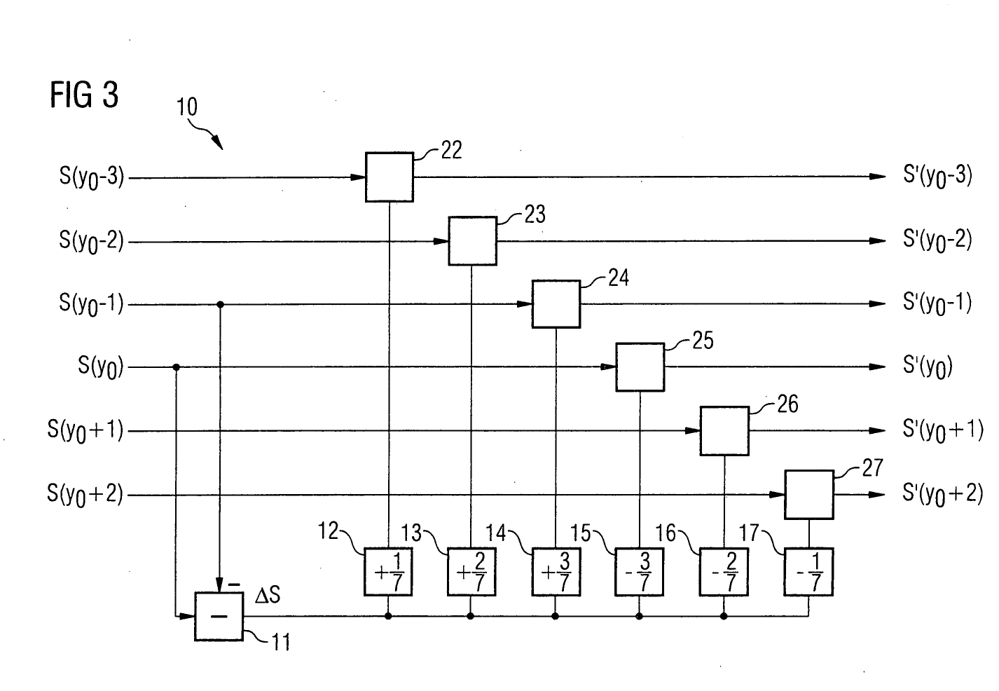

One embodiment of a filter 10 implementing this type of filter function is illustrated in FIG. 3. The filter 10 includes six inputs that receive the image information values s(y_{O}−3), . . . , s(y_{O}+2) of the six pixels y_{O}−3, . . . , y_{O}+2 adjacent to the block boundary 25. The filter 10 includes a subtractor 11 that receives the image information values of the two pixels y_{O-}1,y_{O} immediately adjacent to the block boundary. At the output of this difference element 11, a difference value Δs is provided that is weighted by weighting elements 12, 13, 14, 15, 16, 17 using weighting factors 1/7, 2/7, 3/7, −3/7, −2/7, −1/7, respectively. These variously weighted difference values are added to the input values by adders 22, 34, 24, 25 , 26, 27 to generate the filter output values s'(y_{O}−3), . . . , s'(y_{O}+2). The weighting factors in this embodiment may be a function of the distance of the given pixel from the block boundary, where the absolute value of the given weighting factor increases towards the block boundary.

The described filtering is effected with reference to the example of FIGs. 1A and 1B, column-by-column. The difference value Δs used to determine the filter parameters may be determined separately for each column. In addition, it is also possible to generate a difference value to filter all of the columns. In particular, more than just two pixels may also be utilized to determine this difference value Δs. To generate this difference value Δs, for example, the average of the pixel differences utilized to generate the main gradient value may be taken.

A situation may arise in which the position of an edge of the image located between two homogeneous regions of the image and is not caused by a blocking artifact, accidentally coincides exactly with the position of a block boundary. To prevent such a “real” edge from being smoothed by the filter, the threshold value is preferably defined for the difference Δs, where filtering is omitted if this difference lies above a predetermined threshold value. Given a difference Δs above this threshold value, a “real” edge is assumed, so that no filtering is desired to reduce blocking artifacts.

If based on the secondary gradient value nonhomogeneous image regions are found to be present in the region adjacent to the block boundary 25, then filtering is effected using a second filtering technique designed to filter these nonhomogeneous image regions. This filter examines perpendicularly to the block boundary 25 two pixels of the first image block 2 and two pixels of the second image block 5, that is, the pixels that are also utilized to generate the secondary gradient value. The image information values of these pixels are subjected to a 4-point DCT to obtain four DCT coefficients. In this method, the fourth (antisymmetrical) DCT coefficient is multiplied by a fixed factor which lies, for example, between 0.05 and 0.2 to reduce this coefficient. The image information values for the two pixels immediately adjacent to the block boundary 25 are then determined by applying an IDCT using the three unmodified DCT coefficients and the one modified DCT coefficient. A full 4-point inverse transformation is not required since only two pixels are modified, thereby reducing the computational effort.

In the case of an inverse transformation to determine the image information values of the two pixels immediately adjacent to the block boundary, one must ensure, however, that any modification of the image information values of these pixels relative to the initial values is not greater than half the difference of the original image information values for these two pixels. If required, the image information values for these two pixels obtained by the inverse transformation may be limited accordingly.

The above-described technique in which two different filters are used to reduce artifacts, the filters which are selected as a function of the homogeneity of the image regions adjacent to the block boundary and as a function of the blocking value, may be expanded by providing, for selection, more than two different filters or filtering methods that are selected as a function of the homogeneity of the image regions adjacent to the block boundary. These filters possess different effective widths.

The implementation of this technique is explained below for three different filtering methods. Selection of the filtering is effected as a function of the secondary gradient value which represents a measure of the homogeneity of the regions adjacent to the block boundary.

The first filter or filtering method has a first effective width and is selected when the image regions have a high degree of homogeneity, that is, when the secondary gradient thus has a correspondingly high value which lies above a first threshold.

The second filter or filtering method has a second effective width which is preferably smaller than the first effective width and is selected when the image regions have a lower degree of homogeneity, that is, when the secondary gradient assumes a value that lies between the first threshold value and a smaller second threshold value. The second filter is selected for filtering image regions of medium homogeneity. This filter is suitable specifically for decreasing block artifacts, but is also designed to retain more details than the first filter for very homogeneous regions.

The third filter or filtering method has a third effective width that is smaller than the second effective width, and is selected when the image regions are not homogeneous, that is, when the secondary gradient assumes a value that lies below the second threshold value.

As a first filtering method, the previously described first filtering method is, for example, appropriate for homogeneous regions, which method has an effective width of six pixels; and as the third filtering method, the previously described filtering method is appropriate for active image regions, which method has an effective width of two pixels. The second filtering method can be a filtering method, the effective width of which lies between the first and second effective widths, and the effective width of which is four pixels and which is designed to reduce an artifact found at the block boundary.

The processing can be expanded to use additional filtering techniques by providing additional threshold values for comparison with the secondary gradient value.

The decision as to whether filtering should take place is dependent on the blocking value, where various decision thresholds for the blocking value are provided as a function of the secondary gradient value.

The selection of the filtering technique can also be a function of more than one secondary gradient value. For example, it is possible to generate a first secondary gradient value that considers the pixels near the block boundary 25. With reference to FIG. 1B, these may be, for example, the pixels of lines y_{O}−2, y_{O}−1, y_{O}, y_{O}+1 highlighted by the hatch marks, such that the first secondary gradient value corresponds to the secondary gradient value NG₂₅ generated by equation (2). In addition, a secondary gradient value can be generated that considers pixels further distant from the block boundary 25. With reference to FIG. 1B, these may be, for example, the dotted pixels of lines y_{O}−4, y_{O}−3, y_{O}+2, y_{O}+3. For the purpose of selecting the filtering technique, both secondary gradient values are subjected to a threshold value decision. If both values are below a predetermined value indicating homogeneity, then the presence of a homogeneous region can be assumed that also comprises the pixels located a certain distance away from the block boundary. Accordingly, in this case the first filtering technique may be selected, which comprises the greatest effective width, as long as the artifact detection effected based on the blocking value indicates the presence of an artifact. The blocking value is preferably generated from the main gradient value and the secondary gradient value which is determined from the pixels lying close to the block boundary. However, the blocking value may also be generated from the main gradient value, or the other of the two secondary gradient values, or a mixture of the two.

If the first secondary gradient value lies below the threshold value and the second secondary gradient value lies above the threshold value, then a homogeneous image region is present only adjacent to the block boundary. Accordingly, the second filtering technique having the smaller second effective width is applied for a detected block artifact.

If the first secondary gradient value lies above the threshold value, then no homogeneity is present adjacent to the block boundary. Accordingly, the third filtering method is applied having the smallest effective width in response to a detected blocking artifact.

When using multiple secondary gradients to select the filtering method, preferably only those pixels are considered in the determination of the secondary gradient which lie within the effective width of the filter that is selected as a function of the secondary gradient value. Use of the method described based on the first and second blocks 2, 5 is of course not limited to block boundaries running horizontally but can also be analogously applied for example to block boundaries running vertically. Processing of the image is preferably effected for all the block boundaries occurring in the image.

In addition, there is also the possibility of limiting detection of blocking artifacts and possible subsequent filtering to parts of adjacent image blocks. For example, artifact detection and subsequent filtering may thus be implemented for half-blocks—an approach that would be especially advantageous in the processing of block boundaries running vertically. Since the image data are normally transferred line-by-line, in order to process a vertical block boundary 8 image lines would have to be temporarily stored. The memory requirement can be reduced if processing is effected only for parts of the blocks.

With reference to FIG. 1B, processing of boundary 45 running vertically between the blocks 4 and 5 can be effected in two parts, for example, whereby initially a main gradient value and secondary gradient value are determined only for the pixels of the upper four lines y_{O}, y_{O}+1, y_{O}+2, y_{O}+3 lying adjacent to the boundary 45, and filtering is then implemented as required. The pixels to be considered here are highlighted in FIG. 1B. This can then be followed by a corresponding processing of the lower four lines y_{O}+4, y_{O}+5, y_{O}+6, y_{O}+7.

In one embodiment, a unilateral homogeneity along the block boundary, thus in the example a unilateral homogeneity on the x axis, is determined in the image blocks 2, 5 adjacent to the block boundary, and the main gradient value is weighted as a function of the detection of this unilateral homogeneity. In response to the detection of this unilateral homogeneity, the main gradient value is increased to make a decision to implement a filter. The reason behind this is that blocking artifacts are especially conspicuous in one of the image blocks in the case of unilateral homogeneity, so that filtering can be desirable even given an initially small main gradient value that tends to indicate the absence of a blocking artifact. Instead of increasing the main gradient value in response to the detection of a unilateral homogeneity, it is of course also possible, before evaluating the ratio of the main gradient value to the secondary gradient value, to reduce the secondary gradient value by appropriate weighting.

In order to detect a unilateral homogeneity along the block boundary, pixel pairs are considered in each of the two image blocks, the pixels of which lie immediately adjacent to the block boundary and are located adjacent to each other in the axis of the block boundary. Pixel differences are generated for these pixel pairs, and the absolute values of these pixel differences are. summed to generate a local homogeneity value. This value becomes smaller the more homogeneous is the given image block locally adjacent to the block boundary 25. The homogeneity values generated for the two blocks are compared, where given a significant variation, for example, a difference greater than 30,between the two unilaterally determined homogeneity values a unilateral homogeneity is assumed.

Although the present invention has been illustrated and described with respect to several preferred embodiments thereof, various changes, omissions and additions to the form and detail thereof, may be made therein, without departing from the spirit and scope of the invention.

What is claimed is:

1. An image processing method for reducing blocking artifacts in an image that includes a first image block and a second image block separated by a block boundary, comprising:
generating a main gradient value which is a function of a first pixel difference between a first pixel located in the first image block a second pixel located in the second image block, where the first and second pixel are located adjacent to each other on a first axis running vertically relative to the block boundary;
generating at least one secondary gradient value which is a function of a second pixel difference between at least two pixels located adjacent to each other in the first image block on the first axis, and a function of a third pixel difference between at least two pixels located adjacent to each other in the second image block on the first axis; and
filtering the first and second image blocks, at least in the region of a block boundary between the first and second image blocks as a function of a ratio between the main gradient value and the at least one secondary gradient value.

2. The method of claim 1, where a ratio is generated from the main gradient value and the at least one secondary gradient value to generate a blocking value, and where the step of filtering is effected as a function of whether the blocking value lies above or below a threshold value.

3. The method of claim 1, where the filtering is selectively performed as a function of the secondary gradient value by at least two different filtering technique.

4. The method of claim 1, where the filtering is selectively performed as a function of the secondary gradient value by at least a first or second filtering technique.

5. The method of claim 1, where a first secondary gradient value and a second secondary gradient value are determined, wherein determination of the first secondary gradient value is performed using pixels that are closer to the block boundary than pixels used to determine the second secondary gradient value, the step of filtering is selectively applied as a function of the first and second secondary gradient value.

6. The method of claim 2, where the threshold value of the blocking value is a function of the at least one secondary gradient value.

7. The method of claim 6, where a first threshold value is selected when the secondary gradient value lies below a threshold value, otherwise a second threshold value is selected.

8. The method of claim 7, where the filtering is effected in the first axis, where the number of pixels considered for the filter in the first filtering technique is greater than in the second filtering technique.

9. The method of claim 14, where the first filtering technique is omitted when the absolute value of a difference value which is a function of the image information value of at least one pixel in the first block and of the image information value of at least one pixel in the second block lies above a threshold value.

10. The method of claim 1, where the main gradient value is a function of the pixel difference between at least two pixels located immediately adjacent to each other from the first and second image blocks.

11. The method of claim 10, where the main gradient value is a function of the sum of the absolute values of the pixel differences of the immediately adjacent pixels within the first and second image block along the block boundary.

12. The method of claim 11, where the secondary gradient value is a function of the pixel difference between at least two immediately adjacent pixels of the first image block, one of which lies immediately adjacent to the block boundary, and of the pixel difference between at least two immediately adjacent pixels of the second image block, one of which lies immediately adjacent to the block boundary.

13. The method of claim 12, where the secondary gradient value is a function of the sum of the absolute values of the pixel differences for all the pixel pairs of the first and second image blocks which have two pixels in the same image block, of which one pixel lies immediately adjacent to the block boundary and which are adjacent to each other in the first axis.

14. The method of claim 1, the method having the following procedural steps:
generating a first homogeneity value for the first image block which is a function of the pixel difference between at least two pixels of the first image block which on a second axis running parallel to the block boundary are adjacent to each other;
generating a second homogeneity value for the second image block which is a function of the pixel difference between at least two pixels of the second image block which are adjacent to each other on the second axis; and
comparing the first and second homogeneity values, and weighting the blocking values as a function of the result of the comparison before the step of filtering.
